(19) United States
(12) Patent Application Publication
(10) Pub. No.: US 2016/0059507 A1
(43) Pub. Date: Mar. 3, 2016

(54) CUTTING DEVICE FOR CUTTING PACKING MATERIAL

(71) Applicant: SHU-CHANG KAO, TAICHUNG CITY (TW)

(72) Inventor: SHU-CHANG KAO, TAICHUNG CITY (TW)

(21) Appl. No.: 14/472,925

(22) Filed: Aug. 29, 2014

(51) Int. Cl. B31B 1/20; B26F 1/20; B26F 1/38

(52) U.S. Cl. CPC B31B 1/20; B26F 1/384; B26F 1/20; B31B 2201/143

(57) ABSTRACT

A cutting device includes a base roller, a magnetic roller, a first molding member, a second molding member and a base board. The magnetic roller is perpendicular to the base roller which drives the magnetic roller. The base board is connected to the base roller. The first molding member is attached to the magnetic roller to create slots in the base board. The second molding member has second folding line blades and cutting line blades, and the second molding member is switchable with the first molding member. The second molding member and the base board cut expanded packing boxes from the paper board. The expanded packing boxes include K-lines.

### BACKGROUND OF THE INVENTION

1. Fields of the Invention

The present invention relates to a cutting device, and more particularly, to a cutting device having two rollers with molds connected on the two rollers so as to cut packing boxes having folding lines.

2. Descriptions of Related Art

The conventional packing material usually is made by a paper board and pre-set folding lines are defined in the paper board so that the paper board is folded along the folding lines to form a packing box of desired shape.

Conventionally, the folding lines such as the K-lines or dotted lines of the paper boards are made manually, the workers attach lines on the base board or put wood blocks beneath the base board so that the cutting device can cut the paper boards without damaging the cutting blade. However, the manual way to make the lines requires a lot of time and errors are often seen. The efficiency is low and this reduces the benefits. For the wood blocks put beneath the base board, the hardness of the wood blocks has to be carefully checked, because the incorrect hardness of the wood blocks may cause worse quality of the folding lines on the paper boards.

An improved cutting device (Taiwanese Patent Gazette No. M442268) is known to applicant and comprises a base board, a molding board which is put on the top of the base board. The molding board has a carry board and a marked area which is made by way of laser engraving. A blade is located above the molding board. The cutting device is operated in a plane and the production is not fast enough.

The present invention intends to provide a cutting device which eliminates the shortcomings mentioned above.

### SUMMARY OF THE INVENTION

The present invention relates to a cutting device and comprises a base roller having at least two first bosses extending from the outside thereof. A magnetic roller is located corresponding to the base roller and driven by the base roller so as to rotate in a direction opposite to that of the base roller. The magnetic roller has at least two second bosses extending from the outside thereof. A first molding member is attached on the magnetic roller and has first holes with which the at least two second bosses of the magnetic roller are engaged. The first molding member has multiple first folding line blades. A base board is attached to the base roller and has positioning holes with which the at least two first bosses are engaged. The first folding line blades of the first molding member make create slots in the base board. A second molding member is attached on the magnetic roller and switchable with the first molding member. The second molding member has second holes with which the at least two second bosses of the magnetic roller are engaged. The second molding member has multiple second folding line blades and cutting line blades, wherein the second folding line blades are located corresponding to the slots of the base board. The cutting line blades cut a paper board.

Preferably, the width of the slots is equal to the sum of the thickness of the second folding line blades and two times of the thickness of the paper board.

The primary object of the present invention is to provide a cutting device that cuts expanded packing boxes with folding lines at high speed, and the static electricity of the expanded packing boxes is reduced.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the cutting device of the present invention;

FIG. 2 shows the use of the first molding member and the base board;

FIG. 3 shows the lines on the base board;

FIG. 4 is an enlarged view of the circled portion in FIG. 2;

FIG. 5 shows the use of the second molding member and the base board;

FIG. 6 is an enlarged view of the circled portion in FIG. 5, and

FIG. 7 is the expanded packing box made by the cutting device of the present invention.

### DETAILED DESCRIPTION OF THE PREFERRED EMBODIMENT

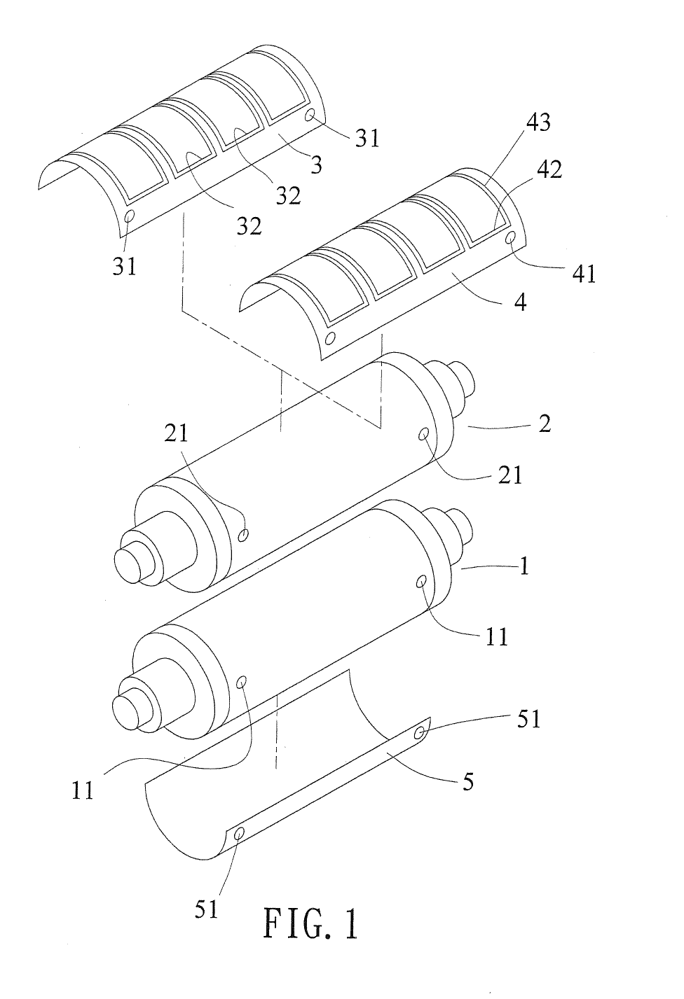

Referring to FIG. 1, the cutting device of the present invention comprises a base roller 1 which is installed to a frame (not shown) and has at least two first bosses 11 extending from the outside thereof. A magnetic roller 2 is installed to the frame and located corresponding to the base roller 1. The magnetic roller 2 is driven by the base roller 1 so as to rotate in the direction opposite to that of the base roller 1. The magnetic roller 2 has at least two second bosses 21 extending from the outside thereof. A first molding member 3 is attached on the magnetic roller 2 and has first holes 31 with which the at least two second bosses 21 of the magnetic roller 2 are engaged. The first molding member 3 has multiple first folding line blades 32. A second molding member 4 is attached on the magnetic roller 2 and switchable with the first molding member 3. The second molding member 4 has second holes 41 with which the at least two second bosses 21 of the magnetic roller 2 are engaged. The second molding member 4 has multiple second folding line blades 42 and cutting line blades 43. A base board 5 is attached to the base roller 1 and has positioning holes 51 with which the at least two first bosses 11 are engaged. The first folding line blades 32 of the first molding member 3 make slots 52 in the base board 5.

When in use, as shown in FIGS. 1-3 and 4-7, the base roller 1 is engaged with the magnetic roller 2 by gears (not shown), so that the base roller 1 drives the magnetic roller 2 in different direction. Alternatively, the base roller 1 can also be driven by a transmission roller (not shown) or by a power source (not shown).

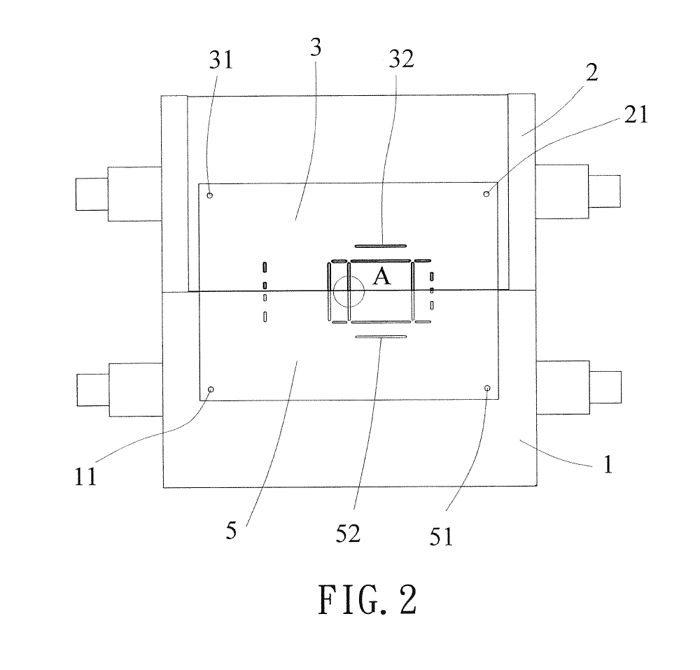

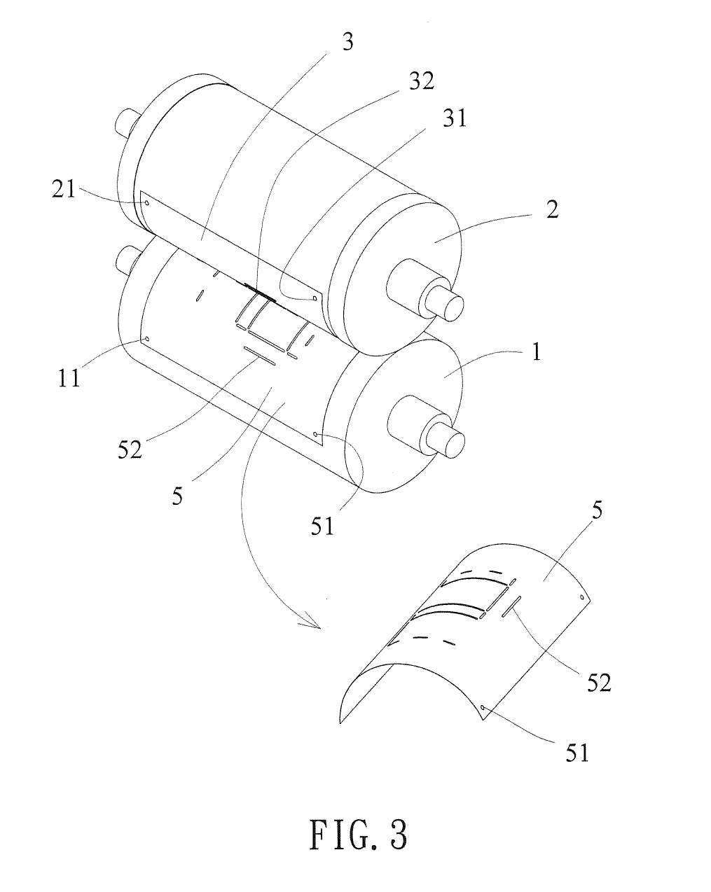

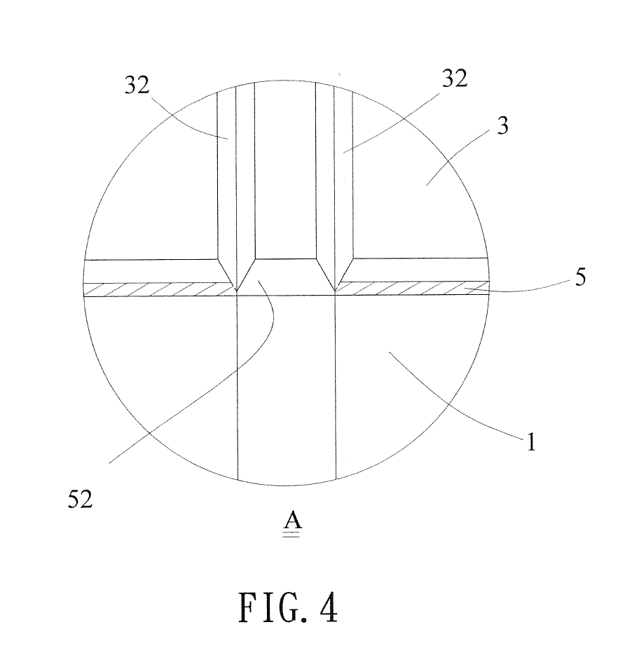

The first molding member 3 is magnetically attached on the magnetic roller 2 and the at least two second bosses 21 of the magnetic roller 2 are engaged with the first holes 31 of the first molding member 3. The base board 5 is located around the base roller 1 by engaging the least two first bosses 11 of the base roller 1 with the positioning holes 51 of the base board 5. The patterns of the first folding line blades 32 are shown in FIG. 2. As shown in FIG. 3, the power source or the like drives the base roller 1 which rotates the magnetic roller 2, so that the first folding line blades 32 of the first molding member 3 make slots 52 in the base board 5, as shown in FIG. 4. The base board 5 is used as a female mold.

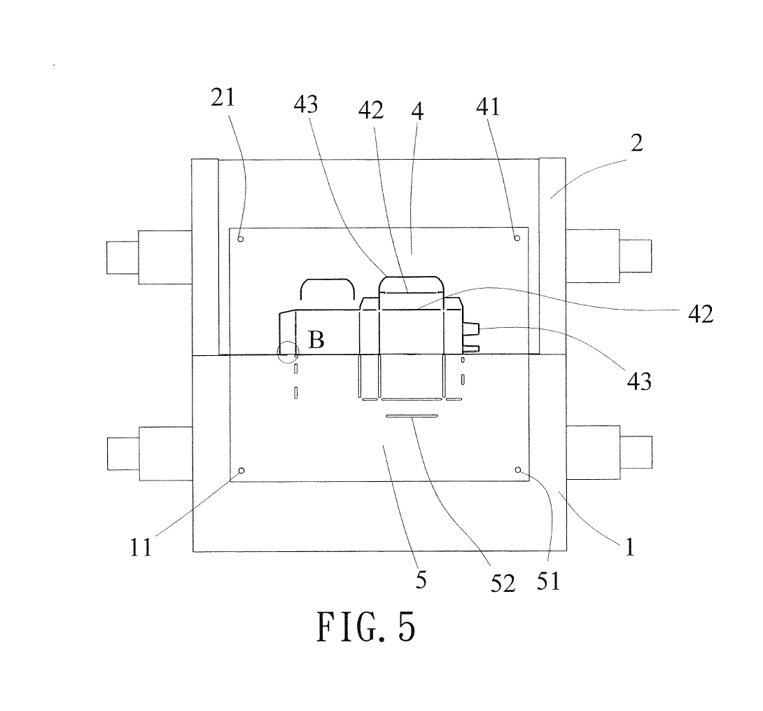

As shown in FIGS. 5 to 7, after the slots 52 are made in the base board 5, the first molding member 3 is removed from the magnetic roller 2, and the second molding member 4 is magnetically attracted to the magnetic roller 2, the patterns of the second folding line blades 42 and the cutting line blades 43 are shown in FIG. 5. The at least two second bosses 21 of the magnetic roller 2 are engaged with the second holes 41 of the second molding member 4. The second folding line blades 42 of the second molding member 4 are located corresponding the slots 52 of the base board 5.

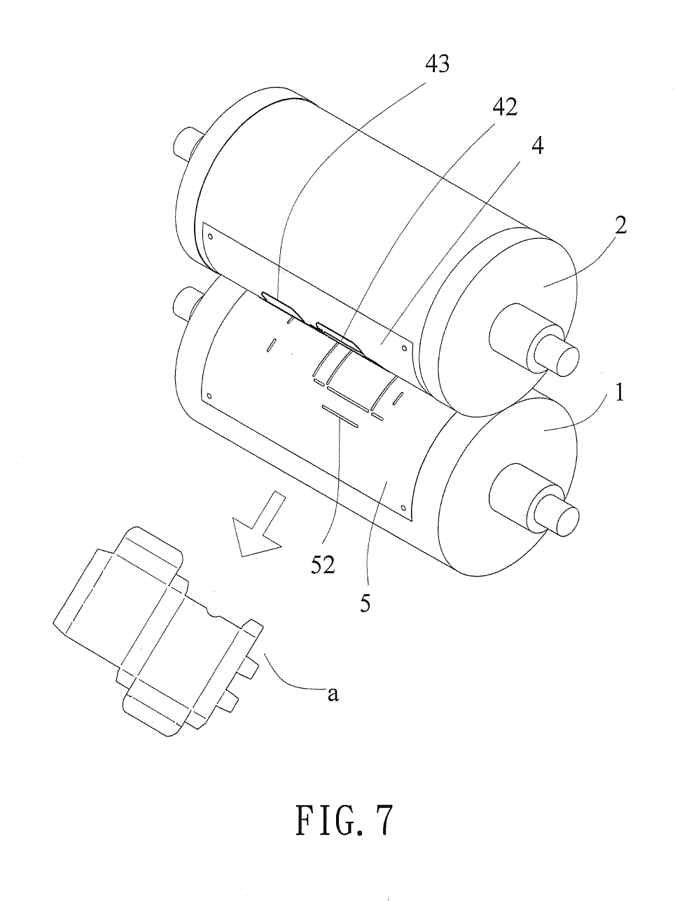

A paper board 6 is inserted between the base roller 1 and the magnetic roller 2, the second molding member 4 and the base board 5 roll on the paper board 6. The paper board 6 is created with K-lines by the cooperation of the second folding line blades 42 of the second molding member 4 and the slots 52 in the base board 5. The cutting line blades 43 of the second molding member 4 cut an expanded packing box, a product (a), from the paper board 6 as shown in FIG. 7.

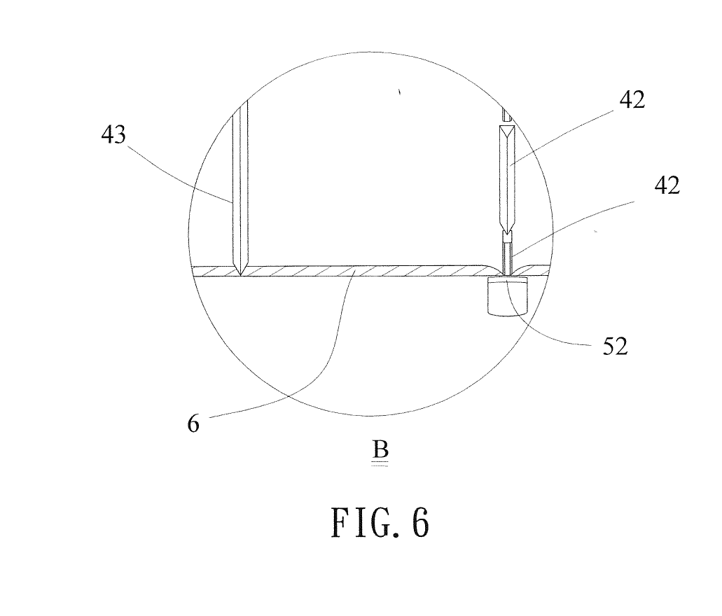

As shown in FIG. 6, assume that the thickness of the paper board 6 is 0.5 mm, the cutting line blades 43 cut the product (a) from the paper board 6. The width of the second folding line blades 42 is 0.7 mm, the width of the slots 52 is 1.7 mm. The width of the slots 52 is equal to the sum of the thickness of the second folding line blades 42 and two times of the thickness of the paper board 6.

The present invention uses rollers to precisely form K-lines in the paper board 6, and the products (a) can be precisely cut. The production speed of the products (a) created by the cutting device of the present invention is quick, and the manufacturing cost is low. The cooperation between the bosses 11, 21 and the first and second holes 31, 41 ensures that the first/second molding member 3, 4 are precisely positioned so that the K-lines and the slots 52 are precisely created.

While we have shown and described the embodiment in accordance with the present invention, it should be clear to those skilled in the art that further embodiments may be made without departing from the scope of the present invention.

What is claimed is:

1. A cutting device comprising:
a base roller having at least two first bosses extending from an outside thereof;
a magnetic roller located corresponding to the base roller and driven by the base roller so as to rotate in a direction opposite to that of the base roller, the magnetic roller having at least two second bosses extending from an outside thereof;
a first molding member attached on the magnetic roller and having first holes with which the at least two second bosses of the magnetic roller are engaged, the first molding member having multiple first folding line blades;
a base board attached to the base roller and having positioning holes with which the at least two first bosses are engaged, the first folding line blades of the first molding member making slots in the base board, and
a second molding member attached on the magnetic roller and switchable with the first molding member, the second molding member having second holes with which the at least two second bosses of the magnetic roller are engaged, the second molding member having multiple second folding line blades and cutting line blades, the second folding line blades located corresponding to the slots of the base board, the cutting line blades cutting a paper board.

2. The cutting device as claimed in claim 1, wherein a width of the slots is equal to a sum of a thickness of the second folding line blades and two times of a thickness of the paper board.
